(19) United States
(12) Patent Application Publication
(10) Pub. No.: US 2004/0266397 A1
(43) Pub. Date: Dec. 30, 2004

(54) Communication device with message management and method therefore

(76) Inventors: Gregory S. Smith, Ocean Ridge, FL (US); Krishna K. Adusumilli, Boca Raton, FL (US); Hugo Normandin, Pompano Beach, FL (US)

Correspondence Address: Randi L. Dulaney, Motorola, Inc., Law Department, 8000 West Sunrise Boulevard, Fort Lauderdale, FL, 33322, US

(21) Appl. No.: 10/603,970

(22) Filed: Jun. 25, 2003

(51) Int. Cl. H04B 1/38

(52) U.S. Cl. 455/412.1; 455/558

(57) ABSTRACT

A communication device (100) includes a memory (120) and a message manager application (140). The memory (120) includes a message memory (150) for storing one or more messages and a contacts memory (155) for storing one or more contacts. Each the stored messages includes a message source (305) and a message receipt time (310). The message manager application (140) compares the message source a message to the stored contacts; and retains storage of the message when its message source is one of the stored contacts.

### BACKGROUND OF THE INVENTION

1. Field of the Invention

This invention relates in general to electronic devices and more particularly to message management within communication devices.

2. Description of the Related Art

With the proliferation of the Internet, the way people communicate is changing. Electronic communication such as electronic mail (email), and real time electronic messaging (e.g. instant messaging and chat messaging) is quickly replacing traditional telephonic communication and handwritten letters. Electronic messaging continues to grow in popularity as a communication tool. The commercial availability of wireless email services and wireless text messaging on portable electronic devices allow users to combine the functions of a cellular telephone, personal organizer, and messaging in one lightweight device. Wired and wireless email offers a cost-effective way to communicate across great distances without requiring high connection speeds.

One drawback to wireless receipt of email and other text messages on a small portable electronic device is the burden it can place on the limited available memory. As technology allows the additional exchange of photos, music, video, and other multimedia files both through wired and wireless networks, this burden increases. Eventually some messages must be removed or stored to a separate memory. Some software applications set an email limit, over which the device is not able to receive additional email. To counteract this burden, some email applications auto-delete email after a certain time period. Auto-deletion keeps email inboxes from reaching their size limits and from becoming too cluttered and hard to manage.

Another popular feature of today's communication devices is the use of a contact list or address book. The contact list feature enables a messaging user to create, organize, and manage a list of friends, family members, and co-workers on their computer, personal digital assistance, or wireless device. Users can create and store different contacts to facilitate electronic communication.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates an electronic block diagram of a communication device.

FIG. 2 illustrates an exemplary embodiment of a user interface notification displayed within the communication device of FIG. 1.

FIG. 3 illustrates an exemplary embodiment of a message inbox displayed within the communication device of FIG. 1.

FIG. 4 illustrates an exemplary embodiment of a contact list displayed within the communication device of FIG. 1.

FIGS. 5 and 6 are flowcharts illustrating various embodiments of the operation of the communication device of FIG. 1.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

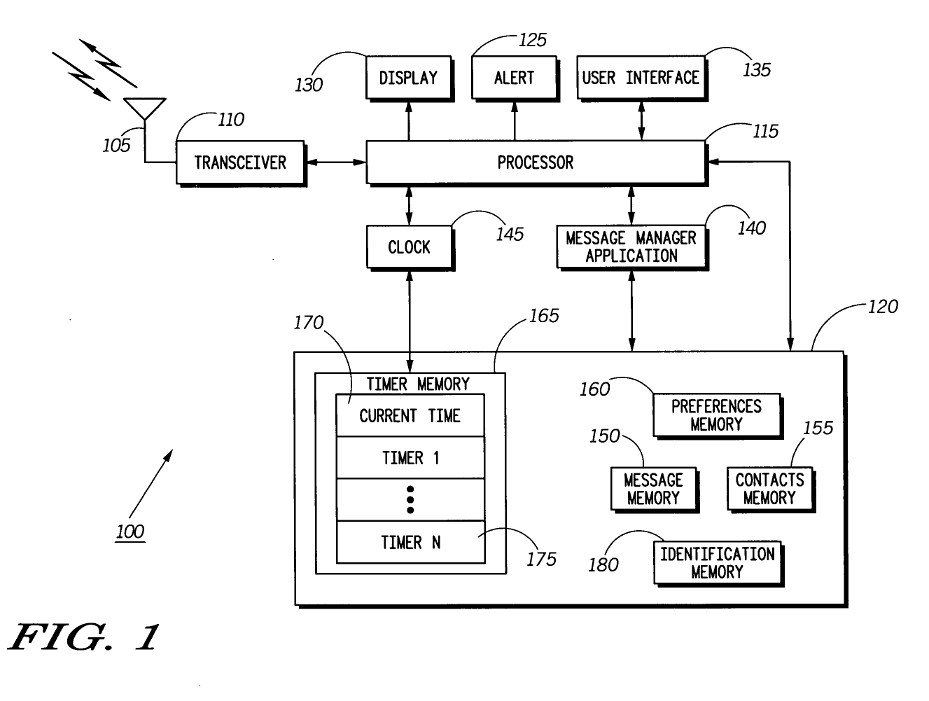

FIG. 1 is an electronic block diagram of a communication device 100. It will be appreciated by one of ordinary skill in the art that the communication device in accordance with the present invention can be a personal computer, a personal digital assistant, or the like having communications capability. Further, it will be appreciated by one of ordinary skill in the art that the communication device, in accordance with the present invention, can be a mobile cellular telephone, a mobile radio data terminal, a mobile cellular telephone having an attached data terminal, or a two way messaging device. Further, the communication device 100 can be a small portable personal computer having wireless communications capability. In the following description, the term “communication device” refers to any of the devices mentioned above or an equivalent.

As illustrated, the communication device 100 preferably includes an antenna 105, a transceiver 110, a processor 115, a memory 120, an alert circuit 125, a display 130, a user interface 135, a message manager application 140, and a clock 145.

The antenna 105 intercepts transmitted signals from one or more communication systems and transmits signals to the one or more communication systems. It will be appreciated by those of ordinary skill in the art that one or more of the communication systems, in accordance with the present invention, can function utilizing any wireless radio frequency (RF) channel, for example, a two-way messaging channel, a mobile cellular telephone channel, or a mobile radio channel. Similarly, it will be appreciated by one of ordinary skill in the art that one or more of the communication systems can function utilizing other types of wireless communication channels such as infrared channels and/or Bluetooth channels. Similarly, it will be appreciated by one of ordinary skill in the art that one or more of the communication systems can function utilizing a wireline communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. The WAN, for example, can use a physical network media such as X.25, Frame Relay, ISDN, Modem dial-up or other media. In the following description, the term “communication system” refers to any of the communication systems mentioned above or an equivalent. Further, in the following description, the term “communication device” refers to any device operating within the communication systems mentioned herein or an equivalent.

The antenna 105 is coupled to the transceiver 110, which employs conventional demodulation techniques for receiving the communication signals. The transceiver 110 is coupled to the processor 115 and is responsive to commands from the processor 115. When the transceiver 110 receives a command from the processor 115, the transceiver 110 sends a signal via the antenna 105 to one or more of the communication systems. In an alternative embodiment (not shown), the communication device 100 includes a receive antenna and a receiver for receiving signals from one or more of the communication systems and a transmit antenna and a transmitter for transmitting signals to one or more of the communication systems. It will be appreciated by one of ordinary skill in the art that other similar electronic block diagrams of the same or alternate type can be utilized for the communication device 100.

Coupled to the transceiver 110, is the processor 115 utilizing conventional signal-processing techniques for processing received messages. It will be appreciated by one of ordinary skill in the art that additional processors can be utilized as required to handle the processing requirements of the processor 115. The processor 115 decodes an identification in the demodulated data of a received message, compares the decoded identification with one or more identifications stored in an identification memory 180 of the memory 120, and when a match is detected, proceeds to process the remaining portion of the received message. The one or more identifications, for example, can be a unique selective call address assigned within a wireless communication system, an electronic mail address, an IP (internet protocol) address or any other similar identification.

To perform the necessary functions of the communication device 100, the processor 115 is coupled to the memory 120, which preferably includes a random access memory (RAM), a read-only memory (ROM), and an electrically erasable programmable read-only memory (EEPROM) (not shown). It will be appreciated by those of ordinary skill in the art that the memory 120 can be integrated within the communication device 100, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 100. The SIM card can be used to transfer a variety of information from/to the communication device 100 and/or any other compatible device. Preferably, the memory 120 includes a timer memory 165, a preferences memory 160, a message memory 150, a contacts memory 155, and the identification memory 180.

Upon receipt and processing of a message or a call, the processor 115 preferably generates a command signal to the alert circuit 125 as a notification that the message has been received and stored or alternatively that a call is waiting for a response. The alert circuit 125 similarly can be utilized for other alerting notifications such as an alarm clock, expiration of a timer 175, or the message memory 150 being at its memory storage limitations. The alert circuit 125 can include a speaker (not shown) with associated speaker drive circuitry capable of playing melodies and other audible alerts, a vibrator (not shown) with associated vibrator drive circuitry capable of producing a physical vibration, or one or more light emitting diodes (LEDs) (not shown) with associated LED drive circuitry capable of producing a visual alert. It will be appreciated by one of ordinary skill in the art that other similar alerting means as well as any combination of the audible, vibratory, and visual alert outputs herein described can be used for the alert circuit 125.

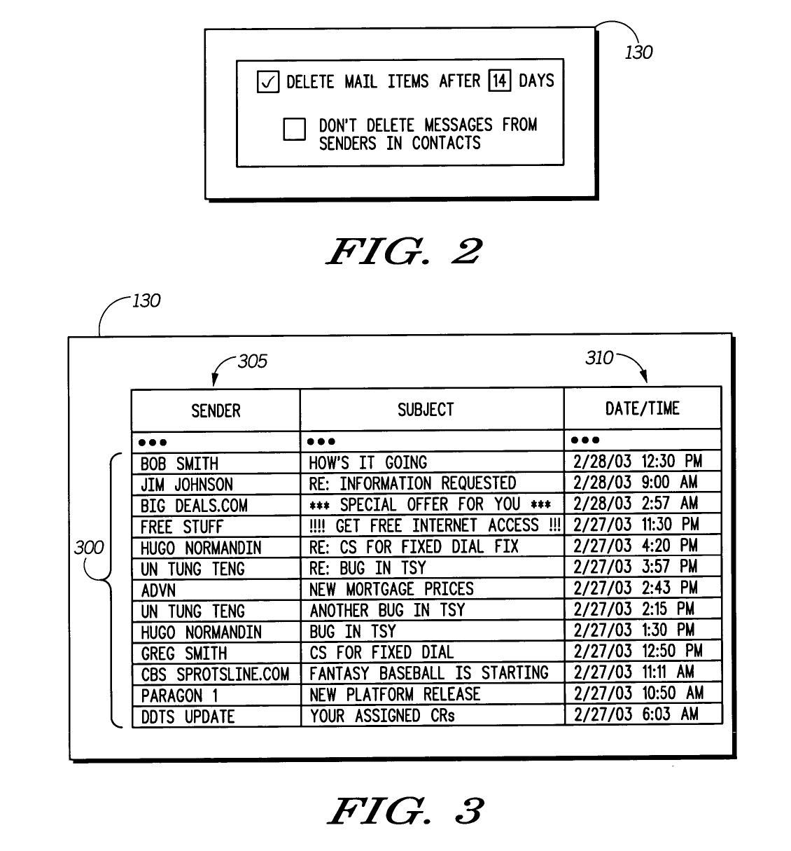

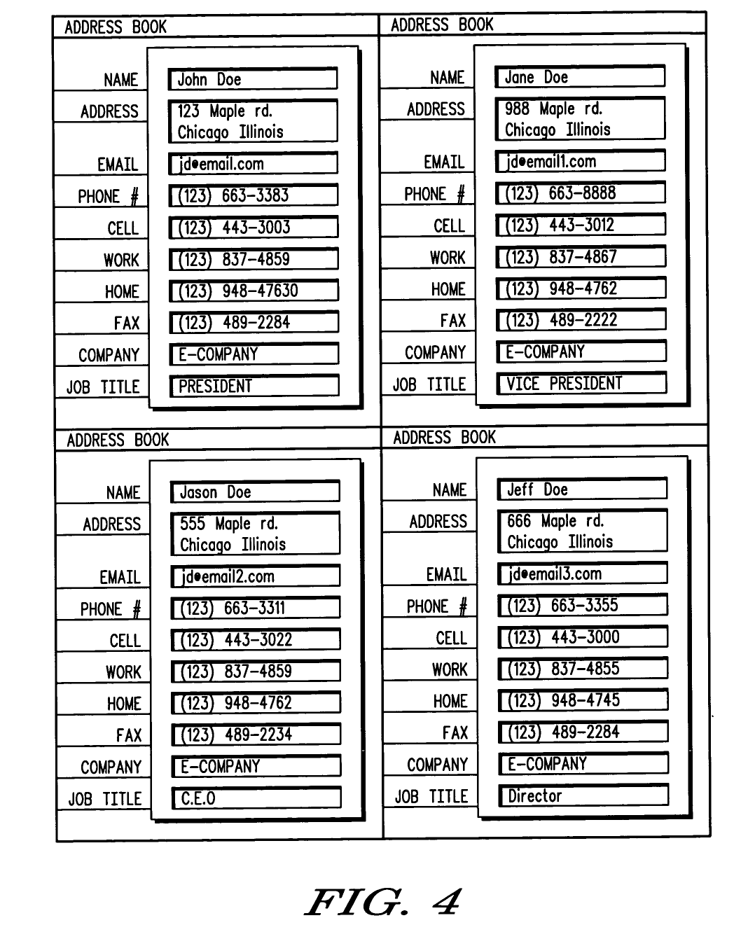

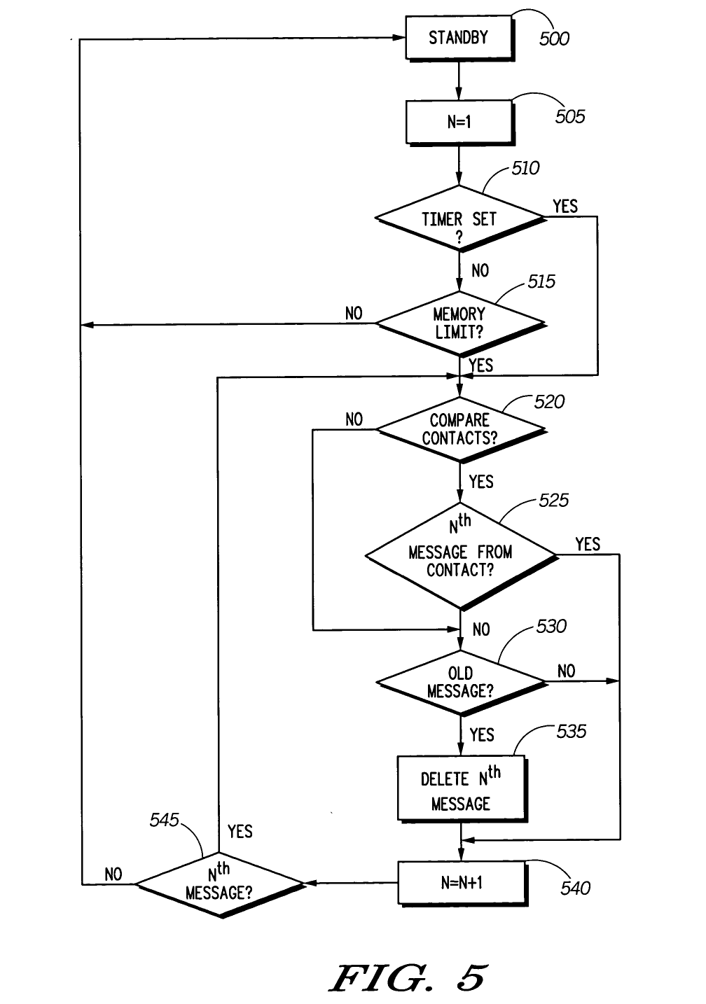

Upon receipt and processing of a message or a received call, the processor 115 preferably also generates a command signal to the display 130 to generate a visual notification. Similarly, the display 130 can be utilized as a means for providing information to the device user. For example, as illustrated in FIG. 2, various user interface notifications can be displayed on the display. Similarly, as illustrated in FIG. 3, the device user's current message inbox can be displayed on the display 130. Similarly, as illustrated in FIG. 4, the device user's current contact list can be displayed on the display. The display can be a liquid crystal display, a cathode ray tube display, one or more organic light emitting diodes, one or more LEDs, a plasma display, or an equivalent.

Preferably, the user interface 135 is coupled to the processor 115. The user interface 135 can include a keypad such as one or more buttons used to generate a button press or a series of button presses. The user interface 135 can also include a voice response system or other similar method of receiving a manual input initiated by the device user. The processor 115, in response to receiving a user input via the user interface 135 performs commands as required. For example, the user interface 135 can be utilized for performing functions related to the messages stored in the message memory 150 such as reading, replying, or deleting one or more stored email messages. The user interface 135 can further be used to perform functions on one or more contacts stored in the contact memory 155 such as accessing, adding, deleting, or changing information related to one or more contacts. The user interface 135 further can be used to change one or more user preferences stored in the preferences memory 160. For example, the device user can set preferences viewed on the display 130 such as “Don't delete messages from senders in contacts” as illustrated in FIG. 2. For example, the device user can choose the option by checking the box next to the preference using the user interface 135.

In a preferred embodiment, the communication device 100 includes the message manager application 140 coupled between the processor 115 and the memory 120. The message manager application 140 can be hard coded or programmed into the communication device 100 during manufacturing, can be programmed over-the-air upon customer subscription, or can be a downloadable application. It will be appreciated that other programming methods can be utilized for programming the message manager application 140 into the communication device 100. It will be further appreciated by one of ordinary skill in the art that the message manager application 140 can be hardware circuitry within the communication device 100.

In one embodiment of the present invention, the message manager application 140 is adapted to automatically delete messages from the message memory 150 when a memory limitation is exceeded. The message manager application 140 can also be adapted to automatically delete individual messages from the message memory 150 upon the expiration of the timer 175 stored in the timer memory 170. For example, as illustrated in FIG. 3, the processor 115 can store the time 310 each of the plurality of messages 300 was received along with the message 300 in the message memory 150. The message manager application 140 can then compare the current time 170 stored in the memory 120 with the received time 310 and when the delta equals the timer value 175, the message is deleted from the message memory 150. For example, when the user does not enable the “Don't Delete Messages From Senders in Contacts” checkbox illustrated in FIG. 2, and the auto delete timer is set to 14 days, then all emails that become over 14 days old are deleted.

Further, and in accordance with the present invention, the message manager application 140 is adapted to compare the contacts stored in the contacts memory 155 with a sender 305 of each of the plurality of messages stored in the message memory 150 and selectively delete only messages in which the sender 305 is not stored within the contacts memory 155. In other words, messages from members of the contact list are exempt from auto-deletion after an expiration period. Returning to the previous example, when the user does enable the option of “Don't delete messages from senders in contacts” by checking the box illustrated in FIG. 2, emails with senders contained with the contacts memory 155 are not deleted after 14 days. The result is the email inbox is cleaned up and valuable email messages are not lost, all done automatically without the user having to worry about it.

The message manager application 140 can further be adapted to automatically file messages after a certain time period. For example, the messages stored in the message memory 150 can be moved to external memory storage after a period of time. In accordance with the present invention, the message manager application 140 can be adapted to store the messages in folders identified to the device user based on contacts stored within the contacts memory 155. For example, the message manager application 140 can be adapted to use the contact's last name followed by first name as the name of the folder. If the folder already exists, the message would be filed in that folder after the expiration period. If no folder exists, the folder would be created and the message then filed in that newly created folder (after the expiration period). The end result is the user's messages are filed away in a way that they are easily retrievable. The number of messages in the user's message inbox is reduced, and messages from people in the user's contacts list are not lost.

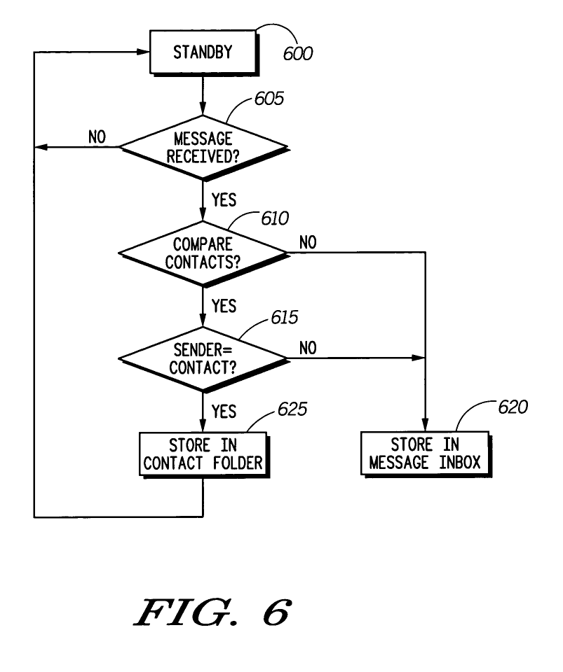

FIG. 5 is a flowchart illustrating one embodiment of the operation of the communication device 100 of FIG. 1. Specifically, FIG. 5 illustrates an exemplary embodiment of the operation of automatic deletion of messages by the message manager application 140 in accordance with the present invention. As illustrated, the process begins with Step 500 in which the communication device 100 is in standby mode. Standby mode runs the communication device 100 with minimal power to conserve battery life. Next, in Step 505, a counter is set to N=1. Next, in Step 510, the process determines whether a timer has been set. For example, the message manager application 140 can query the timer memory 165 of the memory 120 to determine whether one or more timers such as the timer 175 are stored. In Step 515, when no timer is set in Step 510, the process determines whether a memory storage limit has been reached. For example, the message manager application 140 can compare the amount of memory storage space being used by the message memory 150 to a message memory storage limitation set and stored in the preferences memory 160. When the memory storage limitation has not been reached in Step 515, the process cycles back to the standby mode of Step 500. In Step 520, when the memory storage limitation has been reached in Step 515 or a timer has been set in Step 510, the process determines whether the preference to compare message senders to a contact list has been set. For example, the preference can set within the preferences memory 160 or can be a default condition programmed within the communication device 100. In Step 525, when the preference to compare message sources to contacts stored within the contacts memory 155 is set, the sender/source of the Nth message is compared to the contacts stored within the contacts memory 155. In Step 530, when the Nth message sender is not a member of the contacts list stored within the contacts memory 155, and when the contacts comparison preference is not set in Step 520, the process next determines whether the Nth message is an “old” message. For example, the message manager application 140 compares the difference between the current time 170 and the receipt time of the Nth message with the timer 175 stored in the timer memory 165. Similarly, when the memory storage limit has been reached, the message manager application 140 can determine whether the Nth message is the earliest received message stored in the message memory 150. In Step 535, when the Nth message is an “old” message, the Nth message is deleted from the message memory 150. Next, and when the Nth message sender is a contact in Step 525, and when the Nth message is not an “old” message in Step 530, in Step 540, the counter is incremented to N=N+1. Next, in Step 545, the process determines whether the message memory 150 includes an Nth message. When the message memory 150 does not include an Nth message, i.e. all messages stored in the message memory 150 have been checked, the process returns to standby mode of Step 500. When the message memory 150 does include the Nth message in Step 545, the process cycles back to Step 520 and continues to check the Nth message to determine whether or not to delete it.

The method as described herein and illustrated in FIG. 5 provides a method to avoid deleting all electronic messages solely based on a time period expiring. The method of the present invention uses a link to a contacts list to intelligently delete less important email messages after a time period expires. The more important messages (from senders in contacts) are not deleted. The linkage to the user's contacts list allows the user to reduce his/her email inbox size without auto-deleting everything. Further, the auto-deleting of messages in accordance with the present invention is dynamic based on the contacts list. If an entry is added to contacts, then from that point on messages from that contact are no longer auto-deleted. Likewise, if an entry is removed from contacts, from that point on messages from that sender are auto-deleted. As email becomes more and more available on wireless handsets, the present invention provides an intelligent way to save valuable storage space on a portable wireless device without having the user do so much manual house-cleaning but at the same time intelligently keeping the important messages the user cares about. This similarly can be applied to SMS and phonebooks on cellular telephones (another situation where storage space is at a premium).

FIG. 6 is a flowchart illustrating one embodiment of the operation of the communication device 100 of FIG. 1. Specifically, FIG. 6 illustrates an exemplary embodiment of the operation of automatic filing of messages by the message manager application 140 in accordance with the present invention. As illustrated, the process begins with Step 600 in which the communication device 100 is in standby mode. Standby mode runs the communication device 100 with minimal power to conserve battery life. Next, in Step 605, the process determines whether a new message has been received. When no new messages have been received, the process cycles back to standby mode of Step 600. In Step 610, when a new message has been received, the process determines whether the preference to compare the message senders to a contact list has been set. For example, the preference can set within the preferences memory 160 or can be a default condition programmed within the communication device 100. In Step 615, when the preference to compare message sources to contacts stored within the contacts memory 155 is set, the sender/source of the received message is compared to the contacts stored within the contacts memory 155. In Step 620, when the received message sender is not a member of the contacts list stored within the contacts memory 155, and when the contacts comparison preference is not set in Step 610, in Step 620, the received message is stored within the message inbox. The message inbox, for example, can be at least one portion of the message memory 150. In Step 625, when the received message sender/source is a stored contact, the received message is stored in a contact folder associated with the stored contact. For example, the contact folder can be at least a portion of the external memory storage identified by the contact. Alternatively, the received message can be stored within the contacts memory 155 along with the associated contact's other identifying information. The process then cycles back to the standby mode of Step 600.

The method as described herein and illustrated in FIG. 6 provides a unique and novel process for auto-filing based on contacts. Instead of automatically deleting email messages after a certain time period, the user can set a time limit to automatically file email messages to local or external memory storage. The invention automatically matches the identification of the sender of messages with the addresses stored within the contacts list. In one embodiment (not illustrated), an auto-filing time limit can be set. When the auto-filing time limit is reached, similarly to as discussed for auto-deletion in FIG. 5, the sender can be compared to the contact list. If the address of the sender exists in the contacts memory, the message is automatically filed in local storage in a folder with that identifies the contact, such as with the contact's name. The user is then able to turn on auto-filing, set an expiration period, and have all messages filed that are from senders within their contacts list. This method provides a simpler approach to complex email filtering rules, and achieves automatic filing in a method that is one of the more common ways users file their messages. It can be accomplished with enabling one simple option and an expiration, thereby avoiding the traditional approach of requiring the user to set up a filtering rule for each individual email address. This method can dynamically change with the user's contact list. With this approach, if the user deletes an entry in contacts, the filtering stops auto-filing for that entry from that point forward. The process provides a valuable method for any email account where memory space is limited such as wireless communication devices.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for message management within a communication device comprising the steps of:
storing one or more contacts within a contacts memory;
storing one or more received messages within a message memory, wherein each of the stored messages includes a message source;
comparing the message source of at least one message to the one or more stored contacts; and
retaining storage of the at least one message when the message source of the at least one message is one of the stored contacts.

2. A method for message management within a communication device as recited in claim 1, wherein each of the stored messages further includes a message receipt time, the method further comprising the steps of:
setting a timer;
comparing the difference between a current time and the message receipt time of the at least one message to the timer when the message source is not one of the stored contacts; and
deleting the at least one message when the difference is at least the same as the timer.

3. A method for message management as recited in claim 1, wherein each of the stored messages further includes a message receipt time, and wherein each of the one or more contacts has a contact folder, the method further comprising the steps of:
setting a timer;
comparing the difference between a current time and the message receipt time of the at least one message to the timer when the message source is one of the stored contacts;
identifying the contact of the one or more contacts matching the message source of the at least one message when the difference is at least the same as the timer; and
storing the at least one message within the contact folder of the matching contact.

4. A method for message management as recited in claim 1 further comprising the steps of:
reaching a memory storage limit; and
retaining storage of the at least one message when the message source of the at least one message is one of the stored contacts; and
deleting the at least one message when the message source of the at least one message is not one of the stored contacts.

5. A method for message management as recited in claim 1, wherein each of the one or more contacts has a contact folder, the method further comprising the steps of:
identifying the contact of the one or more contacts matching the message source of the at least one message; and
storing the at least one message within the contact folder of the matching contact.

6. A communication device with message management comprising:
a memory comprising:
a message memory for storing one or more messages, wherein each of the stored messages includes a message source and a message receipt time, and
a contacts memory for storing one or more contacts; and
a message manager application coupled to the memory, wherein the message manager application is adapted to:
compare the message source of at least one message to the one or more stored contacts; and
retain storage of the at least one message when the message source of the at least one message is one of the stored contacts.

7. A communication device as recited in claim 6, wherein the memory further comprises a timer memory for storing at least one timer, wherein each of the stored messages further includes a message receipt time, and wherein the message manager application is further adapted to:
compare the difference between a current time and the message receipt time of the at least one message to the at least one timer when the message source is not one of the stored contacts; and
delete the at least one message when the difference is at least the same as the at least one timer.

8. A communication device as recited in claim 6 wherein the message memory further has a memory storage limit, and wherein the message manager application is further adapted to:
delete the at least one message when the message source of the at least one message is not one of the stored contacts when the message memory reaches the memory storage limit; and
retain storage of the at least one message when the message source of the at least one message is one of the stored contacts.

9. A communication device as recited in claim 6, wherein the memory further comprises a contact folder associated with each of the one or more contacts, and wherein the message manager application is further adapted to:
identify the contact of the one or more contacts matching the message source of the at least one message; and
store the at least one message within the contact folder associated with the matching contact.
